(19) United States
(12) Patent Application Publication
(10) Pub. No.: US 2019/0146267 A1
(43) Pub. Date: May 16, 2019

(54) DISPLAY DEVICE

(71) Applicant: SHARP KABUSHIKI KAISHA, Sakai City (JP)

(72) Inventor: SHIGENORI TANAKA, Sakai City (JP)

(21) Appl. No.: 16/186,849

(22) Filed: Nov. 12, 2018

(30) Foreign Application Priority Data
Nov. 14, 2017 (JP) 2017-218875

(51) Int. Cl. G02F 1/1335; G02F 1/1339; G02F 1/133

(52) U.S. Cl. CPC G02F 1/133512; G02F 1/133528; G02F 2001/133388; G02F 1/13306; G02F 1/1339

(57) ABSTRACT

A display device includes a display panel displaying an image on a display surface thereof and including a substrate that has a step portion on a surface on a display surface side, a panel member covering the display surface of the display panel, and a light blocking section disposed between an edge portion of the display panel and an edge portion of the panel member and being fit to the step portion. The light blocking section has a surface opposite the panel member that is farther away from the panel member than the display surface is.

### CROSS REFERENCE TO RELATED APPLICATION

This application claims priority from Japanese Patent Application No. 2017-218875 filed on Nov. 14, 2017. The entire contents of the priority application are incorporated herein by reference.

### TECHNICAL FIELD

The technology described herein relates to a display device.

### BACKGROUND

A display device includes a display panel and a panel member (a touch panel) arranged on a display surface of the display panel. Such a display device is described in Unexamined Japanese Patent Application Publication No. 2002-116877.

A light blocking member may be disposed on a peripheral edge portion of the display panel to prevent leaking of light. In the above configuration including the display panel and the panel member, the light blocking member is disposed between the display panel and the panel member. The display device has been demanded to be reduced in thickness and a distance between the display panel and the panel member is demanded to be smaller. In the configuration including the light blocking member, if the distance between the display panel and the panel member is reduced, the light blocking member may be contacted with both of the display panel and the panel member. Therefore, pressure may act on the display panel via the light blocking member if an external force is applied on the panel member and display unevenness may be caused on the display panel and display quality may be lowered.

### SUMMARY

The technology described herein was made in view of the above circumstances. An object is to restrict lowering of display quality of a display panel.

A display device according to the technology described herein includes a display panel displaying an image on a display surface thereof and including a substrate that has a step portion on a surface on a display surface side, a panel member covering the display surface of the display panel, and a light blocking section disposed between an edge portion of the display panel and an edge portion of the panel member and being fit to the step portion. The light blocking section has a surface opposite the panel member that is farther away from the panel member than the display surface is. According to such a configuration, the light blocking section is less likely to be contacted with the panel member and pressure from the panel member is less likely to act on the display panel via the light blocking section. Thus, the pressure is less likely to act on the display panel and display quality is less likely to be lowered. With the configuration including the step portion on the substrate, a plate thickness of the substrate is partially small and the substrate is reduced in weight compared to a configuration without having the step portion. The light blocking section is positioned easily by fitting it to the step portion.

According to the technology described herein, display quality of display panel is less likely to be lowered.

### BRIEF DESCRIPTION OF THE DRAWINGS

FIG. 1 is a plan view of a liquid crystal panel according to a first embodiment.

FIG. 2 is a cross-sectional view of a liquid crystal display device taken along line II-II in FIG. 1.

FIG. 3 is a cross-sectional view illustrating a liquid crystal panel and a touch panel.

FIG. 4 is a cross-sectional view of the liquid crystal display device taken along line IV-IV in FIG. 1.

FIG. 5 is a cross-sectional view illustrating a liquid crystal panel and a touch panel according to Comparative Example 1.

FIG. 6 is a cross-sectional view illustrating the liquid crystal panel and the touch panel mounted on the liquid crystal panel according to Comparative Example 1.

FIG. 7 is a cross-sectional view of a liquid crystal panel according to Comparative Example 2.

FIG. 8 is a plan view illustrating a liquid crystal panel according to a second embodiment.

### DETAILED DESCRIPTION

### First Embodiment

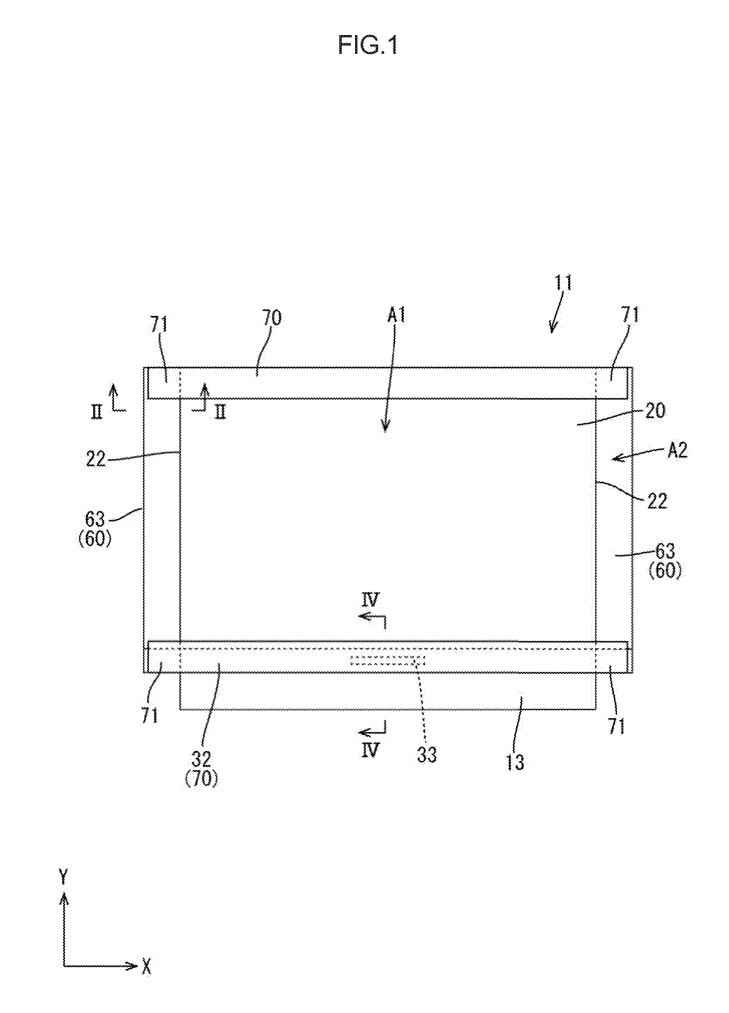

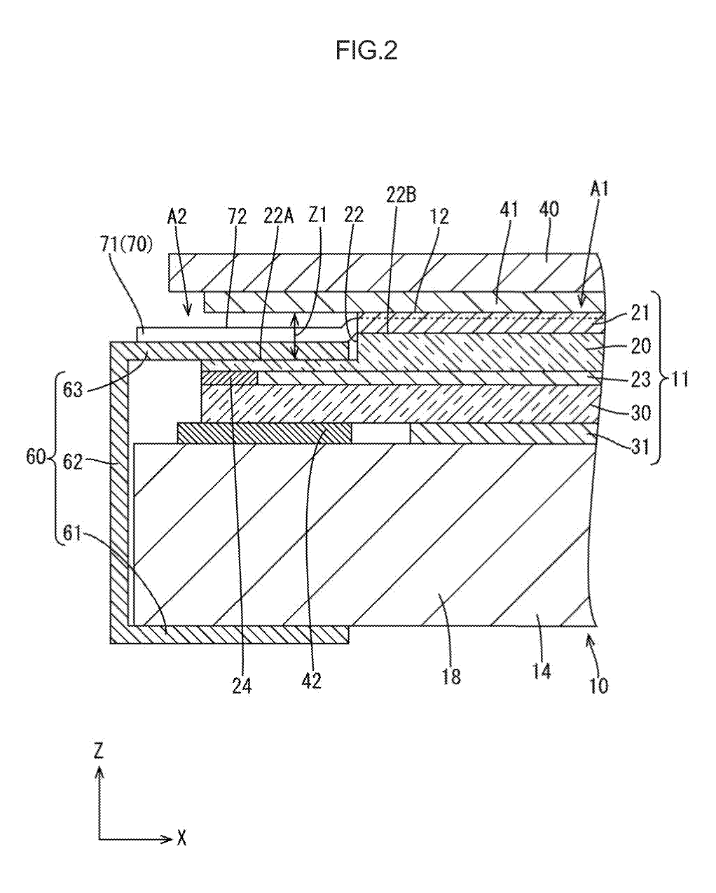

A first embodiment of the present technology will be described with reference to FIGS. 1 to 7. As illustrated in FIGS. 1 and 2, a liquid crystal display device 10 (a display device) includes a liquid crystal panel 11 (a display panel), a touch panel 40 (a panel member), and a backlight device 14 (a lighting device). The liquid crystal panel 11 is configured to display images. The touch panel 40 covers a display surface 12 of the liquid crystal panel 11. The backlight device 14 is an external light source configured to supply light to the liquid crystal panel 11. As illustrated in FIG. 2, the backlight device 14 includes a chassis 18, a light source (not illustrated) such as a cold cathode tube, a LED, and an organic EL, and an optical member (not illustrated). The chassis 18 has a substantially box shape opening toward a front side (toward the liquid crystal panel 11). The light source is arranged within the chassis 18 and the optical member is arranged to close an opening of the chassis 18. The optical member has a function of converting light emitted by the light source into planar light. The liquid crystal panel 11 includes a display area A1 in which images are displayed and a non-display area A2 around the display area A1.

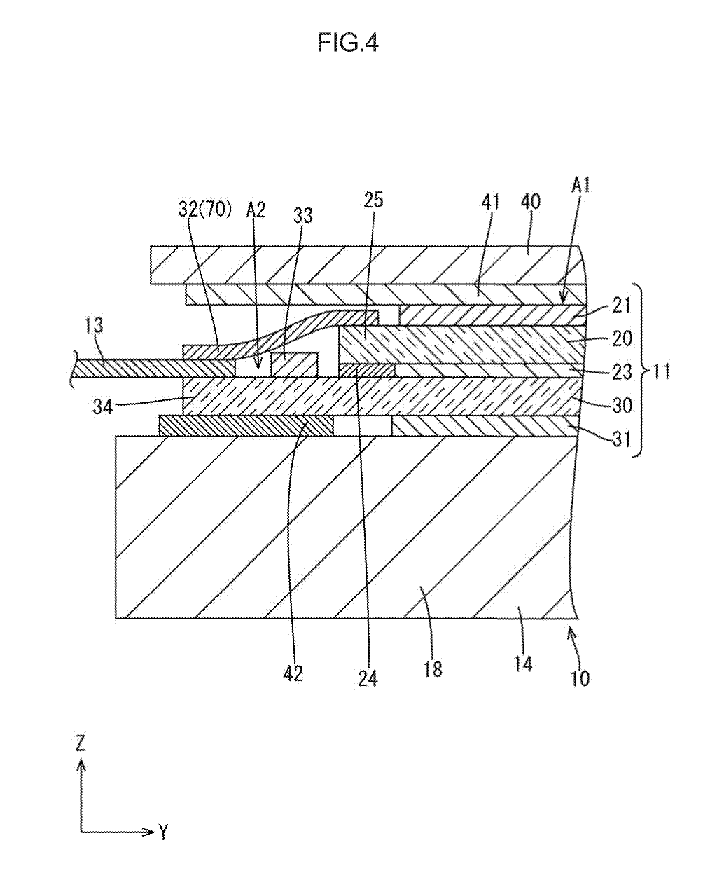

As illustrated in FIG. 4, a flexible circuit board 13 is connected to one side of the liquid crystal panel 11 and the liquid crystal panel 11 is electrically connected to a control circuit board (not illustrated) through the flexible circuit board 13. The control circuit board is configured to supply various kinds of input signals to a driver 33. The driver 33 is configured to process input signals supplied from the control circuit board and generate output signals and output the output signals to the display area A1 of the liquid crystal panel 11 and drive the liquid crystal panel 11. The liquid crystal display device 10 according to this embodiment may be used in various kinds of electronic devices (not illustrated) such as mobile phones (including smartphones), notebook computers (including tablet computers), wearable terminals (including smart watches), handheld terminals (including electronic books and PDAs), portable video game players, and digital photo frames.

As illustrated in FIG. 2, the liquid crystal panel 11 includes a pair of substrates 20 and 30 that are disposed opposite each other and a liquid crystal layer 23 between the substrates 20 and 30. The liquid crystal layer 23 includes liquid crystal molecules that are substances with optical characteristics that vary according to application of an electric field. One of the substrates 20 and 30 on the front side (a front surface side, an upper side in FIG. 2) is a CF substrate 20 (a counter substrate) and one on the back side (a rear surface side) is an array substrate 30 (an active matrix substrate, a component substrate). Polarizing plates 21 and 31 are bonded to outer surfaces of the substrates 20 and 30, respectively. The polarizing plate 21 is bonded to a surface of the CF substrate 20 opposite the touch panel 40 and a surface of the polarizing plate 21 opposite the touch panel 40 is the display surface 12. The CF substrate 20 has a quadrangular shape and includes color filters, an overcoat film, an alignment film (not illustrated) on an inner surface side (a liquid crystal layer side) of a glass substrate. The color filters include color portions of three colors of red (R), green (G), and blue (B) that are arranged in a matrix. Each of the color portions is opposite each of the pixels on the array substrate 30.

The array substrate 30 has a quadrangular shape and includes various kinds of films on an inner surface side of a glass substrate. The films are formed on the glass substrate with the photolithography method. On the inner surface side (the liquid crystal layer side, on an upper side in FIG. 2) of the glass substrate, thin film transistors (TFTs, display components), which are switching components, and pixel electrodes are arranged in a matrix (columns and rows) in the display area A1. The touch panel 40 is fixed to the liquid crystal panel 11 with a transparent adhesive tape 41. The liquid crystal panel 11 is fixed to the backlight device 14 at respective peripheral edge portions thereof with an adhesive tape 42.

As illustrated in FIG. 2, light blocking tapes 60, 70 are attached to peripheral edge portions of the backlight device 14 and the liquid crystal panel 11. The light blocking tapes 60, 70 are black and have light blocking properties. As illustrated in FIG. 1, the light blocking tape 60 is disposed on peripheral edge portions along a pair of short sides (along the Y-axis direction) of the outer edge portions of the liquid crystal panel 11 and extends along the short side. The light blocking tape 70 is disposed on peripheral edge portions along a pair of long sides (along the X-axis direction) of the outer edge portions of the liquid crystal panel 11 and extends along the long side.

The light blocking tape 60 has a substantially U-shape in a cross-sectional view in FIG. 2. The light blocking tape 60 includes a first extend section 61, a second extend section 62, and a third extend section 63. The first extend section 61 covers the backlight device 14 from a rear side. The second extend section 62 covers the backlight device 14 from a side. The third extend section 63 covers the liquid crystal panel 11 from a front side. The third extend section 63 of the light blocking tape 60 and the light blocking tape 70, which are configured as a light blocking section, are disposed between the peripheral edge portion of the liquid crystal panel 11 and the peripheral edge portion of the touch panel. As illustrated in FIG. 1, the light blocking tape 70 overlaps the third extend section 63 of the light blocking tape 60 at a corner of the rectangular liquid crystal panel 11. The light blocking tape 70 overlaps the third extend section 63 at end portions 71 thereof. Namely, the two light blocking tapes 60 and 70 that are perpendicular to each other overlap at the corners of the liquid crystal panel 11. According to such a configuration, a clearance is less likely to be formed between the light blocking tapes 60 and 70 at the corner of the liquid crystal panel 11.

As illustrated in FIG. 2, the CF substrate 20 (specifically, the glass substrate of the CF substrate 20) has a step portion 22 at the peripheral edge portion thereof on a surface opposite the touch panel 40 (a surface of the substrate of the display panel opposite the panel member). The step portion 22 extends in the Y-axis direction and is configured by lowering a surface 22A (a bottom surface of the step portion) on an outer side of the CF substrate 20 than a surface 22B on an inner side (on a right side in FIG. 2). Namely, the CF substrate has a plate thickness smaller in the step portion 22 than other portion. The third extend section 63 of the light blocking tape 60 and the end portion 71 of the light blocking tape 70 (one end portion in an elongated direction) are put on the step portion 22. Namely, the third extend section 63 of the light blocking tape 60 and the end portion 71 of the light blocking tape 70 configure the light blocking section that is fit to the step portion 22. The light blocking tape 70 has a surface 72 facing the touch panel 40 (a surface of the light blocking section opposite the panel member). The surface 72 is farther away from (at a lower side in FIG. 2) the touch panel 40 than the display surface 12 is. Only the third extend section 63 of the light blocking tape 60 may be fit to the step portion 22.

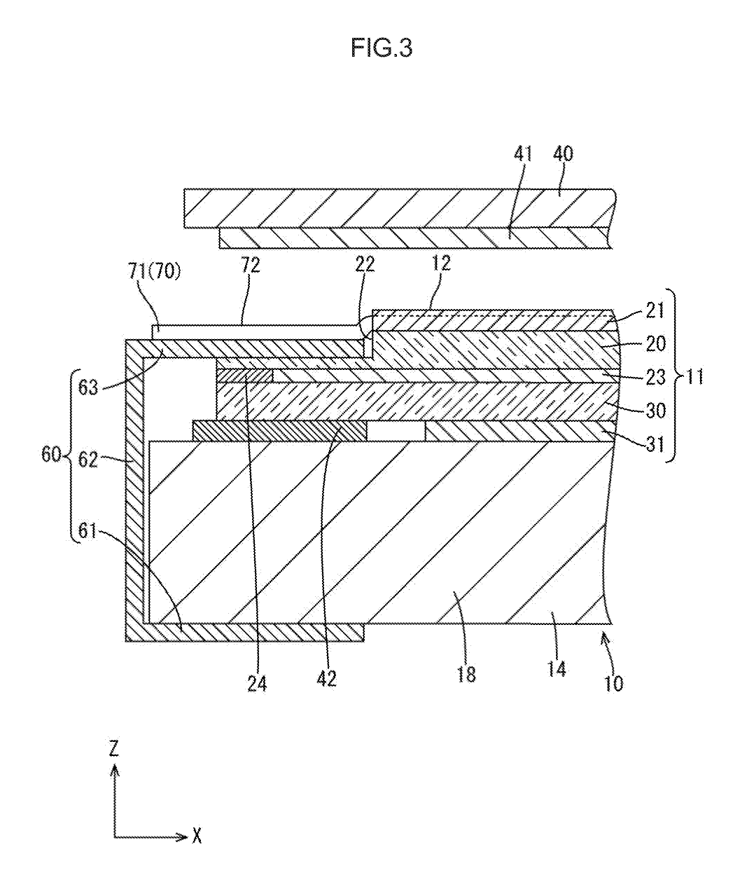

In this embodiment, the peripheral edge portion of the adhesive tape 41 covers the step portion 22 from the front side. An opposing distance Z1 between the bottom surface of the step portion 22 and the rear surface of the adhesive tape 41 is larger than a total of a thickness of the third extend section 63 of the light blocking tape 60 and a thickness of the light blocking tape 70. As illustrated in FIG. 3, in mounting the touch panel 40 on the liquid crystal panel 11, the adhesive tape 41 on the touch panel 40 is put on the display surface 12 (a front surface of the polarizing plate 21) of the liquid crystal panel 11 after the light blocking tapes 60 and 70 are attached to the liquid crystal panel 11. The adhesive tape 41 may not be provided on a part of the touch panel 40 overlapping the step portion 22.

As illustrated in FIG. 2, the liquid crystal panel 11 includes a sealing member 24 between the peripheral edge portion of the CF substrate 20 and the peripheral edge portion of the array substrate 30. The sealing member 24 seals the liquid crystal layer 23. The third extend section 63 of the light blocking tape 60 and the end portion 71 of the light blocking tape 70 overlap the sealing member 24 and the CF substrate 20 (the substrate on a display surface side of the pair of substrates).

As illustrated in FIG. 4, on a long side section (one side of the display panel) of the liquid crystal panel 11 having the flexible circuit board 13, the peripheral edge portion 34 of the array substrate 30 is on an outer side with respect to the liquid crystal panel 11 (on a side direction of the liquid crystal panel 11, on the left side in FIG. 4) than the peripheral edge portion 25 of the CF substrate 20. A driver 33 for driving the liquid crystal panel 11 is arranged on a surface of the peripheral edge portion 34 of the array substrate 30 opposite the touch panel 40. As illustrated in FIG. 1, the light blocking tape 70 is disposed along each of the long sides of the liquid crystal panel 11. As illustrated in FIG. 4, the light blocking tape 70 extending along the long side of the liquid crystal panel 11 having the flexible circuit board 13 is referred to as a light blocking tape 32 (a driver-side light blocking member). The light blocking tape 32 overlaps the surface of the peripheral edge portion 34 of the array substrate 30 opposite the touch panel 40 and the surface of the peripheral edge portion 25 of the CF substrate 20 opposite the touch panel 40.

Next, advantageous effects of this embodiment will be described. Since this embodiment includes the light blocking tapes 60 and 70, light is less likely to leak outward through a space between the peripheral edge portion of the liquid crystal panel 11 and the peripheral edge portion of the touch panel 40. The light blocking tapes 60 and 70 are fit to the step portion 22 of the liquid crystal panel 11 and the surface 72 opposite the touch panel 40 is farther away from the touch panel 40 than the display surface 12 is. According to such a configuration, the light blocking tape 70 is less likely to be contacted with the touch panel 40 and the pressure from the touch panel 40 is less likely to act on the liquid crystal panel 11 via the light blocking tapes 60 and 70. Thus, the pressure is less likely to act on the liquid crystal panel 11 and display quality is less likely to be lowered.

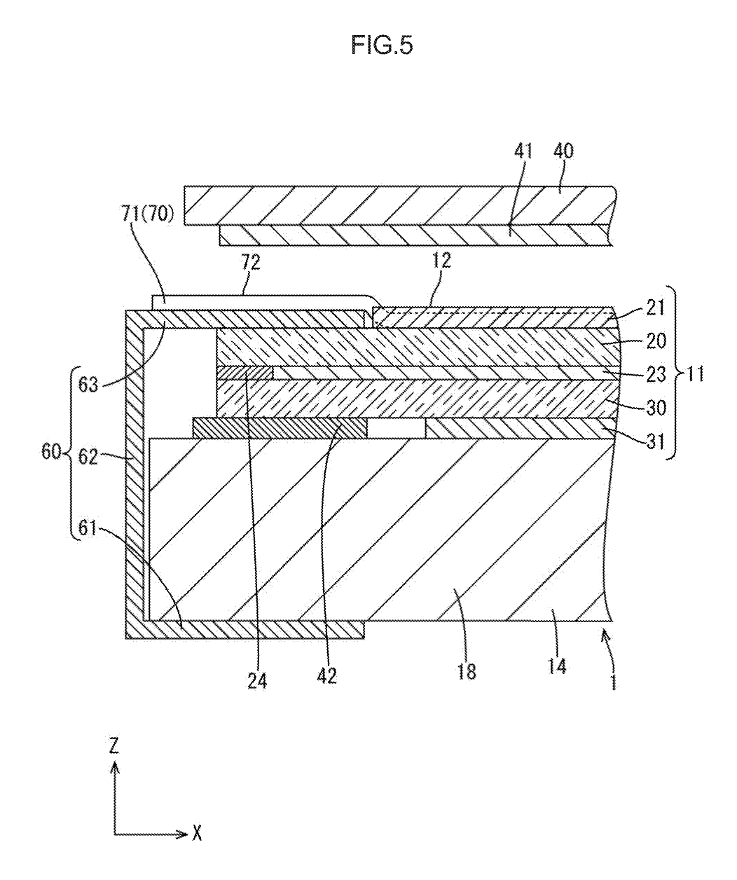

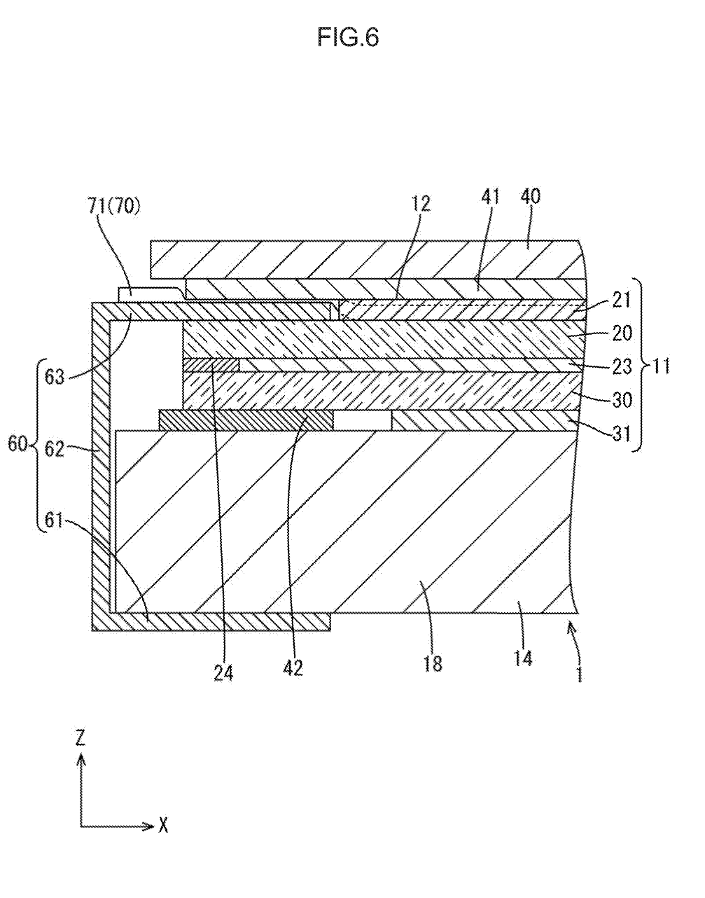

As illustrated in FIGS. 5 and 6, the CF substrate 20 according to a comparative example dos not have the step portion 22 and the surface 72 of the light blocking tape 70 opposite the touch panel 40 may be at a higher level than the display surface 12. In such a configuration, if the touch panel 40 is mounted on the CF substrate 20, the light blocking tape 70 is pressed down and pressure acts on the liquid crystal panel 11 as illustrated in FIG. 6. This may not occur in the present embodiment. The CF substrate 20 has the step portion 22. With this configuration, a plate thickness of the CF substrate 20 is partially small and the CF substrate 20 is reduced in weight compared to a configuration without having the step portion 22. The light blocking tapes 60, 70 are positioned easily by fitting them to the step portion 22.

The liquid crystal panel 11 includes the polarizing plate 21 on the surface of the CF substrate 20 opposite the panel member and the polarizing plate 21 has the display surface 12 on the surface thereof opposite the touch panel 40. The surface of the polarizing plate 21 restricts the touch panel 40 from being moved toward the light blocking tapes 60, 70. Accordingly, the touch panel 40 is less likely to be contacted with the light blocking tape 70.

The liquid crystal panel 11 has the corners and the two light blocking tapes 60 and 70 are overlapped each other at the corners. With such a configuration including the two light blocking tapes 60 and 70 overlapped at the corners, a space is less likely to be formed between the two light blocking tapes 60 and 70. However, with the configuration including the two light blocking tapes 60 and 70 overlapped with each other, a thickness of the light blocking section is likely to be increased and the light blocking tape 70 is likely to be contacted with the touch panel 40 compared to a configuration of the light blocking section configured with one light blocking tape. In the above configuration including the step portion 22, the light blocking tape 70 is less likely to be contacted with the touch panel 40.

The adhesive tape 41 that fixes the touch panel 40 to the liquid crystal panel 11 is disposed between the liquid crystal panel 11 and the touch panel 40. As the thickness of the adhesive tape 41 is increased, the distance between the liquid crystal panel 11 and the touch panel 40 is increased and the light blocking tape 70 is less likely to be contacted with the touch panel 40. However, if the adhesive tape 41 is thick, it is difficult to reduce a thickness of the liquid crystal display device 10. Even in the above configuration having the small distance between the liquid crystal panel 11 and the touch panel 40 by reducing the thickness of the adhesive tape 41, the light blocking tape 70 is less likely to be contacted with the touch panel 40. Therefore, the thickness of the adhesive tape 41 can be reduced and the liquid crystal display device 10 can be reduced in thickness.

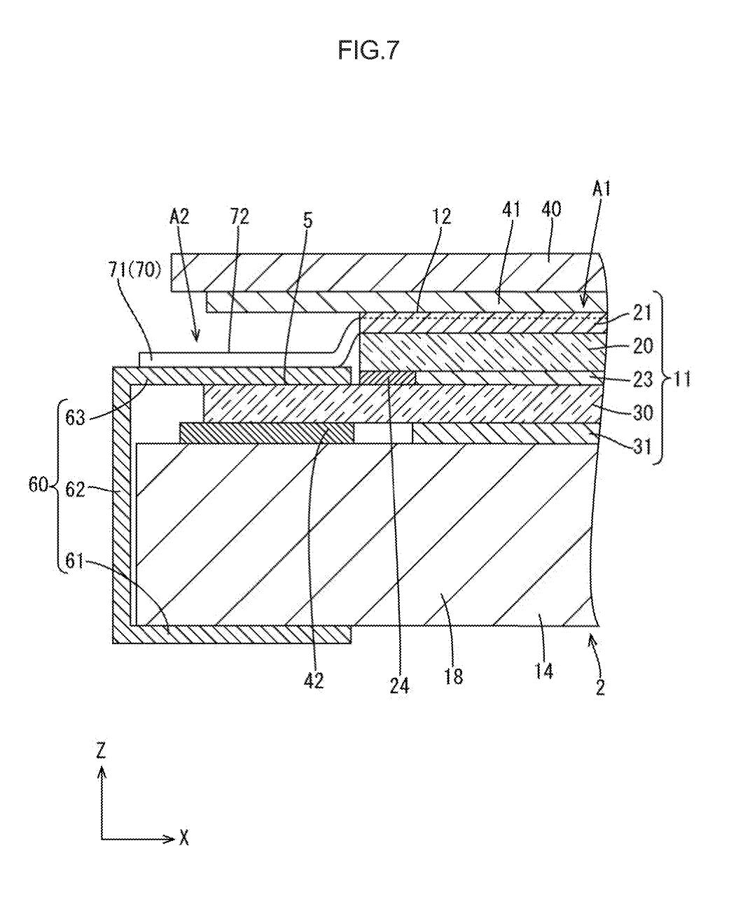

The liquid crystal panel 11 includes the substrates 20 and 30 that are opposite each other, the liquid crystal layer 23 disposed between the substrates 20 and 30, and the sealing member 24 disposed between the peripheral edge portions of the respective substrates 20 and 30 and sealing the liquid crystal layer 23. The light blocking tapes 60, 70 are disposed to overlap the sealing member 24 and the CF substrate 20. As illustrated in FIG. 7, a liquid crystal panel 2 according to a comparative example includes the CF substrate 20 and the array substrate 30 such that the peripheral edge portion of the array substrate 30 projects outward than the peripheral edge portion of the CF substrate 20 with respect to the liquid crystal panel 11. The light blocking tapes 60, 70 are arranged on a surface 5 of the projected peripheral edge portion (not overlapping the CF substrate 20) of the array substrate 30 opposite the touch panel 40. With such a configuration, the light blocking tapes 60, 70 are away from the touch panel 40 by the thickness of the CF substrate 20 and the light blocking tapes 60, 70 are less likely to be contacted with the touch panel 40.

However, in the configuration of FIG. 7, the light blocking tapes 60, 70 do not overlap the CF substrate 20 and therefore, the sealing member 24 is required to be arranged on an inner side than the light blocking tapes 60, 70 with respect to the liquid crystal panel 11. Accordingly, the display area of the liquid crystal panel 11 is decreased by such arrangement of the sealing member 24. In the present embodiment including the step portion 22, the light blocking tapes 60, 70 and the sealing member 24 are overlapped with each other and the display area of the liquid crystal panel 11 is less likely to be decreased.

The liquid crystal panel 11 includes the rectangular array substrate 30 and the rectangular CF substrate 20 that is opposite the array substrate 30 and the liquid crystal panel 11 has a rectangular shape. On one side of the liquid crystal panel 11, the peripheral edge portion 34 of the array substrate 30 is on the outer side than the peripheral edge portion 25 of the CF substrate 20 with respect to the liquid crystal panel 11. The driver 33 for driving the liquid crystal panel 11 is arranged on the surface of the peripheral edge portion 34 of the array substrate 30 opposite the touch panel 40. The liquid crystal panel 11 further includes the light blocking tape 32 overlapping the surface of the peripheral edge portion 34 of the array substrate 30 opposite the touch panel 40 and the surface of the peripheral edge portion 25 of the CF substrate 20 opposite the touch panel 40. With such a configuration, the light blocking tape 32 overlaps the portion of the liquid crystal panel 11 closer to the inner area (the display area A1) compared to the configuration including the light blocking tape 32 overlapping only the peripheral edge portion 34 of the array substrate 30. Therefore, the light is further less likely to leak outside the liquid crystal display device 10.

### Second Embodiment

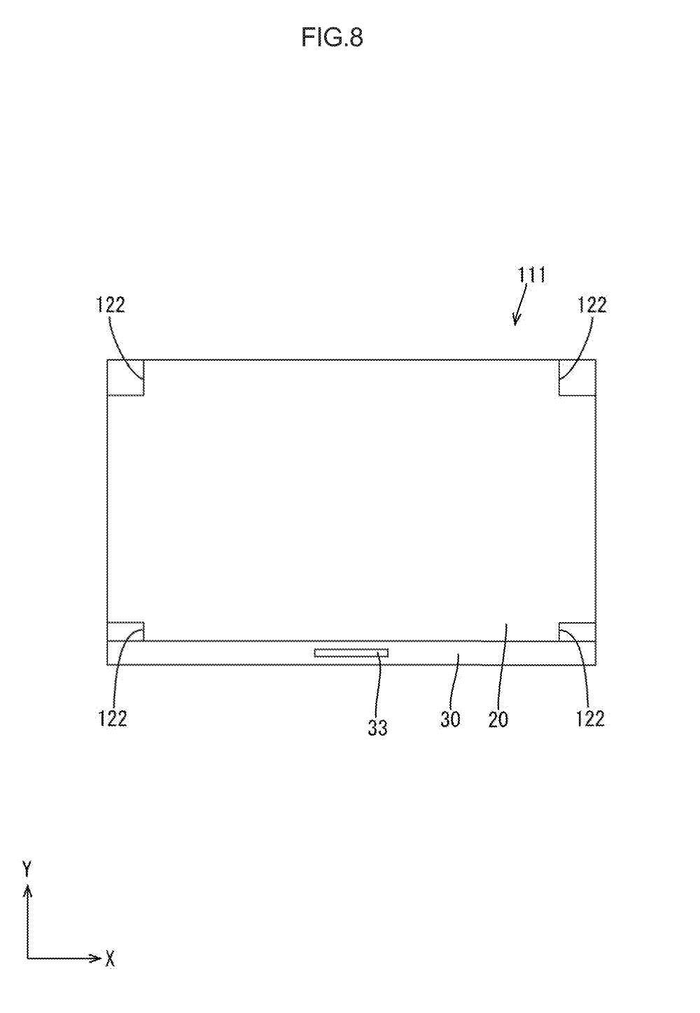

A second embodiment of the present technology will be described with reference to FIG. 8. Components same as those of the above embodiment are provided with same numbers or symbols and will not be described. A liquid crystal panel 111 according to this embodiment includes step portions 122 only at four corners of the CF substrate 20 (four corners, sections corresponding to corners of the liquid crystal panel 111) as illustrated in FIG. 8. The light blocking tapes 60, 70 (the third extend section 63 of the light blocking tape 60, the end portions 71 of the light blocking tape 70, see FIG. 1, not illustrated in FIG. 8) are fit to the step portions 122. According to such a configuration, the CF substrate 20 has greater rigidity compared to the configuration including the step portion extending along an entire periphery of the peripheral edge portion of the liquid crystal panel 111.

### Other Embodiments

The technology described herein is not limited to the embodiments described in the above sections and the drawings. For example, the following embodiments may be included in a technical scope.

(1) A cover panel protecting the liquid crystal panel may be used as the panel member.

(2) An organic EL panel or a plasma display panel may be used as the display panel.

(3) The light blocking section may be configured with one light blocking tape. A configuration of the light blocking section is not necessarily a tape but may be altered as appropriate.

1. A display device comprising:
a display panel displaying an image on a display surface thereof and including a substrate that has a step portion on a surface on a display surface side;
a panel member covering the display surface of the display panel; and
a light blocking section disposed between an edge portion of the display panel and an edge portion of the panel member and being fit to the step portion, the light blocking section having a surface opposite the panel member that is farther away from the panel member than the display surface is.

2. The display device according to claim 1, wherein
the display panel is a liquid crystal panel,
the liquid crystal panel includes a polarizing plate disposed on the surface of the substrate opposite the panel member, and
the display surface is a surface of the polarizing plate opposite the panel member.

3. The display device according to claim 1, wherein
the display panel has a corner, and
the light blocking section includes two light blocking tapes overlapped with each other at the corner.

4. The display device according to claim 3, wherein the step portion is included at a position of the substrate corresponding with the corner.

5. The display device according to claim 1, further comprising an adhesive tape between the display panel and the panel member to fix the panel member to the display panel.

6. The display device according to claim 1, wherein
the display panel is a liquid crystal panel including a pair of substrates opposite each other, a liquid crystal layer disposed between the substrates, and a sealing member disposed between edge portions of the respective substrates to seal the liquid crystal layer, and
the light blocking section is disposed in a portion of one of the substrates closer to the display surface and overlapping the sealing member.

7. The display device according to claim 1, wherein
the display panel has a quadrangular shape and includes an array substrate having a quadrangular shape and a counter substrate having a quadrangular shape and disposed opposite the array substrate, and
the array substrate has an edge portion that is on an outer side than an edge portion of the counter substrate with respect to the display panel on one of sides of the display panel,
the display device further comprising:
a driver configured to drive the display panel and disposed on a surface of the edge portion of the array substrate opposite the panel member; and
a driver-side light blocking member overlapping the surface of the edge portion of the array substrate opposite the panel member and a surface of the edge portion of the counter substrate.
